(19) United States
(12) Patent Application Publication
(10) Pub. No.: US 2023/0234558 A1
(43) Pub. Date: Jul. 27, 2023

(54) CONTROL APPARATUS FOR HYBRID ELECTRIC VEHICLE

(71) Applicants: TOYOTA JIDOSHA KABUSHIKI KAISHA, Toyota-shi Aichi-ken (JP); BluE Nexus Corporation, Anjo City Aichi Prefecture (JP)

(72) Inventors: Yukimasa Nishimura, Nagoya-shi Aichi-ken (JP); Takafumi Rikiishi, Toyota-shi Aichi-ken (JP)

(73) Assignees: TOYOTA JIDOSHA KABUSHIKI KAISHA, Toyota-shi Aichi-ken (JP); BluE Nexus Corporation, Anjo City Aichi Prefecture (JP)

(21) Appl. No.: 18/100,600

(22) Filed: Jan. 24, 2023

(30) Foreign Application Priority Data
Jan. 26, 2022 (JP) 2022-010484

(51) Int. Cl. B60W 20/40; B60K 6/52; B60K 17/354; B60K 6/387; B60K 6/442

(52) U.S. Cl. CPC B60W 20/40; B60K 6/52; B60K 17/354; B60K 6/387; B60K 6/442; B60W 2510/1015; B60Y 2200/92; B60Y 2300/42

(57) ABSTRACT

A control apparatus for a hybrid electric vehicle that includes (i) an engine, (ii) a first electric motor, (iii) a second electric motor, (iv) first wheels, (v) second wheels and (vi) an engagement device disposed between the engine/first electric motor and the first wheels. The engagement device establishes and cuts off transmission of a power of the engine/first electric motor to the first wheels, by connecting and disconnecting between an input rotary member and an output rotary member. During running of the vehicle in a running mode in which the engagement device is released and the vehicle is caused to run by a power of the second electric motor, it is determined whether the engagement device is being released or not, based on (a) a rotational speed difference between the input and output rotary members and (b) a rotational state of the engine or the first electric motor.

### CROSS REFERENCE TO RELATED APPLICATION

This application claims priority from Japanese Patent Application No. 2022-010484 filed on Jan. 26, 2022, the disclosure of which is herein incorporated by reference in its entirety.

### FIELD OF THE INVENTION

The present disclosure relates to a control apparatus for a hybrid electric vehicle that includes (i) an engine, (ii) a first electric motor, (iii) a second electric motor, (iv) first wheels to which a power of each of the engine and the first electric motor is transmittable and (v) second wheels to which a power of the second electric motor is transmittable.

### BACKGROUND OF THE INVENTION

There is known a hybrid electric vehicle that includes (i) an engine, (ii) a first electric motor, (iii) a second electric motor, (iv) first wheels to which a power of each of the engine and the first electric motor is transmittable, (v) second wheels to which a power of the second electric motor is transmittable, and (vi) an engagement device which is provided in a power transmission path such that the engagement device is located between the engine and the first wheels in the power transmission path and is located between the first electric motor and the first wheels in the power transmission path, wherein the engagement device is configured to establish and cut off transmission of the power of each of the engine and the first electric motor to the first wheels, and wherein the hybrid electric vehicle can run in a running mode in which the second wheels are driven by the power of the second electric motor with the first wheels being disconnected from the engine and the first electric motor by release of the engagement device. A hybrid electric vehicle disclosed in JP2011-98663A is an example of such a hybrid electric vehicle. This Japanese Patent Application Publication teaches execution of a series running in which, during running of the hybrid electric vehicle with the second wheels being driven by the power of the second electric motor, an electric-power generation control is executed to cause the first electric motor to be rotated by the power of the engine and to supply the generated electric power to the second electric motor.

### SUMMARY OF THE INVENTION

By the way, during running of the vehicle in the above-described running mode, the engagement device, which should be released, could be engaged, for example, due to a mechanical failure or the like. In such an event, unintended power is transmitted to the first wheels. For detecting such an erroneous engagement of the engagement device, it is necessary to constantly monitor if the engagement device is being released during the running in the above-described running mode. For example, it might be possible to determine whether the engagement device is being released or nor, based on a rotational speed difference between rotary members that are connected and disconnected to each other by the engagement device. However, where the rotary members, which are connected and disconnected to each other by the engagement device, are rotatable independently of each other, rotational speeds of the respective rotary members could coincide with each other even when the engagement device is being released. In such a case, it could be erroneously determined that the engagement device is being engaged.

The present disclosure was made in view of the background art described above. It is therefore an object of the present disclosure to provide a control apparatus for a hybrid electric vehicle that can run in a running mode in which second wheels are driven by a power of a second electric motor with release of an engagement device that is provided in a power transmission path such that the engagement device is located between the engine and the first wheels in the power transmission path and is located between the first electric motor and the first wheels in the power transmission path, wherein the control apparatus is capable of accurately determining whether the engagement device is being released or not during running of the hybrid electric vehicle in the above-described running mode.

The object indicated above is achieved according to the following aspects of the present disclosure.

According to a first aspect of the disclosure, there is provided a control apparatus for a hybrid electric vehicle that includes (i) an engine, (ii) a first electric motor, (iii) a second electric motor, (iv) first wheels to which a power of each of the engine and the first electric motor is transmittable, (v) second wheels to which a power of the second electric motor is transmittable, and (vi) an engagement device which is provided in a power transmission path such that the engagement device is located between the engine and the first wheels in the power transmission path and between the first electric motor and the first wheels in the power transmission path. The engagement device is configured to establish and cut off transmission of the power of each of the engine and the first electric motor to the first wheels, by connecting and disconnecting between an input rotary member and an output rotary member. The control apparatus is configured to establish a running mode in which the engagement device is released and the vehicle is caused to run by the power of the second electric motor. The control apparatus comprises a determination portion configured, during running of the vehicle in the running mode, to determine whether the engagement device is being released or not, based on (a) a rotational speed difference between the input rotary member and the output rotary member and (b) one of a rotational state of the engine and a rotational state of the first electric motor.

According to a second aspect of the disclosure, in the control apparatus according to the first aspect of the disclosure, the vehicle includes a transmission provided in the power transmission path, and the engagement device is a transmission engagement device provided in the transmission, wherein the determination portion is configured to estimate the rotational speed difference between the input rotary member and the output rotary member, based on a rotational speed difference between a rotational speed of an input shaft of the transmission and an estimated rotational speed of the input shaft that is calculated from a rotational speed of an output shaft of the transmission and a gear ratio of the transmission.

According to a third aspect of the disclosure, in the control apparatus according to the first or second aspect of the disclosure, there is further provided a hybrid control portion configured, during running of the vehicle in the running mode, to execute a series running of the vehicle in which an electric power is generated by the first electric motor that is rotated with use of the power of the engine, and the vehicle is caused to run by the second electric motor to which the electric power generated by the first electric motor is supplied.

According to a fourth aspect of the disclosure, in the control apparatus according to any one of the first through third aspects of the disclosure, the determination portion is configured to determine that the engagement device is being engaged, in a case in which a first state has lasted for at least first predetermined time and a second state has lasted for at least second predetermined time, wherein the first state is a state in which the rotational speed difference between the input rotary member and the output rotary member is not larger than a first predetermined value, and wherein the second state is a state in which a deviation amount between a rotational speed of one of the engine and the first electric motor and a target rotational speed of the one of the engine and the first electric motor is not smaller than a second predetermined value.

In the control apparatus according to the first aspect of the disclosure, during the running of the vehicle in the running mode in which the vehicle is caused to run by the power of the second electric motor with the engagement device being released, it is determined whether the engagement device is being released or not, based on (a) the rotational speed difference between the input rotary member and the output rotary member that are connected and disconnected by the engagement device and (b) one of the rotational state of the engine and the rotational state of the first electric motor. Therefore, even in a case in which the rotational speed of the input rotary member of the engagement device and the rotational speed of the output rotary member of the engagement device accidently coincide with each other even through the engagement device is actually being released, it is possible to accurately determine whether the engagement device is being released or not, because the rotational state of the engine or the rotational state of the first electric motor is taken into account in the determination as to whether the engagement device is being released or not.

In the control apparatus according to the second aspect of the disclosure, the rotational speed difference between the input rotary member and the output rotary member is estimated based on the rotational speed difference between the rotational speed of the input shaft of the transmission and the estimated rotational speed of the input shaft that is calculated from the rotational speed of the output shaft of the transmission and the gear ratio of the transmission. Therefore, the rotational speed difference between the input rotary member and the output rotary member can be estimated by a sensor that is conventionally provided, even without additional provision of a sensor configured to detect the rotational speed of the input rotary member and the rotational speed of the output rotary member.

In the control apparatus according to the third aspect of the disclosure, the series running is executed whereby the electric power is generated by the first electric motor that is rotated with use of the power of the engine, and the vehicle is caused to run by the second electric motor to which the electric power generated by the first electric motor is supplied. In this instance, there is a case in which, even though the engagement device is actually released, the rotational speed of the input rotary member and the rotational speed of the output rotary member accidently coincide with each other. Even in such a case, since the rotational state of the engine or the rotational state of the first electric motor is taken into account in the determination as to whether the engagement device is being released or not. Therefore, it is possible to accurately determine whether the engagement device is being released or not.

In the control apparatus according to the fourth aspect of the disclosure, it is determined whether the engagement device is being engaged, depending on whether or not the first state has lasted for at least the first predetermined time and the second state has lasted for at least the second predetermined time, wherein the first state is a state in which the rotational speed difference between the input rotary member and the output rotary member is not larger than the first predetermined value, and the second state is a state in which the deviation amount between the rotational speed of one of the engine and the first electric motor and the target rotational speed of the one of the engine and the first electric motor is not smaller than the second predetermined value. Therefore, the determination as to whether the engagement device is being engaged or not can be made accurately.

### BRIEF DESCRIPTION OF THE DRAWINGS

FIG. 1 is a view schematically showing a construction of a hybrid electric vehicle to which the present disclosure is applied, for explaining major portions of control functions and control systems that are provided to perform various control operations in the vehicle;

FIG. 2 is a flow chart showing a main part of a control routine executed by an electronic control apparatus shown in FIG. 1;

FIG. 3 is a time chart showing, by way of examples, outcomes of controls executed by the electronic control apparatus shown in FIG. 1; and

FIG. 4 is a view schematically showing a construction of a hybrid electric vehicle according to another embodiment of the present disclosure.

### DETAILED DESCRIPTION

Hereinafter, there will be described embodiments in detail with reference to the accompanying drawings. It is noted that figures of the drawings are simplified or deformed as needed, and each portion is not necessarily precisely depicted in terms of dimension ratio, shape, etc.

### First Embodiment

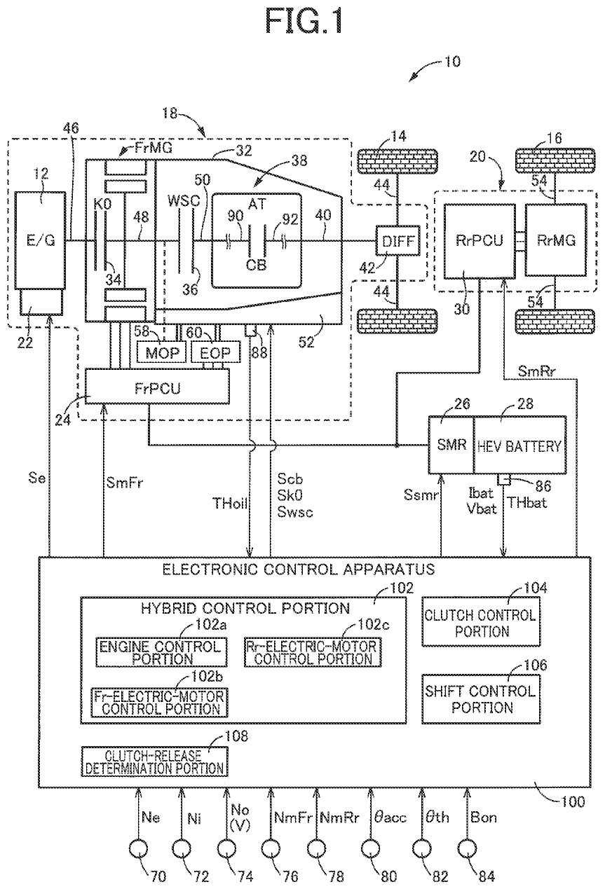

FIG. 1 is a view schematically showing a construction of a hybrid electric vehicle 10 (hereinafter simply referred to as “vehicle 10”) to which the present disclosure is applied, for explaining major portions of control functions and control systems that are provided to perform various control operations in the vehicle 10. In FIG. 1, the vehicle 10 is a four-wheel drive hybrid electric vehicle that includes front wheels 14, rear wheels 16, an engine 12, a front electric motor FrMG and a rear electric motor RrMG, wherein the engine 12 and the front electric motor FrMG cooperate to constitute a front-wheel drive power source for driving the front wheels 14, and the rear electric motor RrMG constitutes a rear-wheel drive power source for driving the rear wheels 16. The vehicle 10 further includes a front unit 18 provided in a power transmission path between the engine 12 and the front wheels 14, and a rear unit 20 provided for driving the rear wheels 16.

The engine 12 is a known internal combustion engine such as gasoline engine and diesel engine. The vehicle 10 is provided with an engine control device 22 that includes a throttle actuator, a fuel injection device and an ignition device. With the engine control device 22 being controlled by an electronic control apparatus 100 that is described below, an engine torque Te, which is an output torque of the engine 12, is controlled.

Each of the front electric motor FrMG and the rear electric motor RrMG is a motor generator having a function serving as a motor configured to generate a mechanical power from an electric power and a function serving as a generator configured to generate an electric power from a mechanical power.

The front electric motor FrMG is connected to an HEV battery 28 provided in the vehicle 10, through a front inverter 24 (FrPCU) and a system main relay 26 (SMR) provided in the vehicle 10. The front inverter 24 is controlled by the electronic control apparatus 100 whereby a FrMG torque TmFr as an output torque of the front electric motor FrMG is controlled. The FrMG torque TmFr serves as a power driving torque when acting as a positive torque for acceleration, with the front electric motor FrMG being rotated in a forward direction that is the same as a direction of rotation of the engine 12 during operation of the engine 12. The FrMG torque TmFr serves as a regenerative torque when acting as a negative torque for deceleration, with the front electric motor FrMG being rotated in the forward direction.

The front electric motor FrMG receives the electric power from the HEV battery 28 through the front inverter 24 and the system main relay 26, and generates the power for driving the vehicle 10, in place of or in addition to the engine 12. Further, the front electric motor FrMG generates the electric power based on the power of the engine 12 or a driven power transmitted from the front wheels 14. The electric power generated by the front electric motor FrMG is supplied to the HEV battery 28 through the front inverter 24 and the system main relay 26 so as to be stored in the HEV battery 28, or is supplied to the rear electric motor RrMG so as to drive the rear electric motor RrMG. The electric power corresponds to an electric energy unless they are to be distinguished from each other. The power corresponds to a force or a torque unless they are to be distinguished from each other.

The rear electric motor RrMG is connected to the HEV battery 28 through a rear inverter 30 (RrPCU) and the system main relay 26 (SMR) provided in the vehicle 10. The rear inverter 30 is controlled by the electronic control apparatus 100 whereby an RrMG torque TmRr as an output torque of the rear electric motor RrMG is controlled. The RrMG torque TmRr serves as a power driving torque when acting as a positive torque for acceleration, with the rear electric motor RrMG being rotated in the forward direction. The RrMG torque TmRr serves as a regenerative torque when acting as a negative torque for deceleration, with the rear electric motor RrMG being rotated in the forward direction.

The rear electric motor RrMG generates the power for driving the vehicle 10, by the electric power supplied from the HEV battery 28 through the rear inverter 30 and the system main relay 26, or by the electric power generated by the front electric motor FrMG. Further, the rear electric motor RrMG generates the electric power based on the driven power transmitted from the rear wheels 16. The electric power generated by the rear electric motor RrMG is supplied to the HEV battery 28 through the rear inverter 30 and the system main relay 26 so as to be stored in the HEV battery 28. The HEV battery 28 is an electric storage device to and from which the electric power is supplied from and to the front electric motor FrMG and the rear electric motor RrMG.

The front unit 18 is constructed such the power of each of the engine 12 and the front electric motor FrMG is transmittable to the front wheels 14. The front unit 18 includes, in addition to the engine 12, a K0 clutch 34 (K0), a casing 32, an input clutch 36 (WSC) and an automatic transmission 38, such that the K0 clutch 34 (K0), input clutch 36 (WSC) and automatic transmission 38 are provided inside the casing 32 that is a non-rotary member fixed to a body of the vehicle 10. The K0 clutch 34 is a clutch which is provided in a power transmission path between the engine 12 and the front wheels 14 and which is located between the engine 12 and the front electric motor FrMG in the power transmission path. The input clutch 36 is a clutch which is provided in the power transmission path and which is located between the K0 clutch 34 and the automatic transmission 38 in the power transmission path. It is noted that the front wheels 14 correspond to “first wheels” recited in the appended claims, and that the front electric motor FrMG corresponds to “first electric motor” recited in the appended claims.

The automatic transmission 38 is located between the engine 12 and the front wheels 14 in the power transmission path, and is located between the front electric motor FrMG and the front wheels 14 in the power transmission path. The front unit 18 further includes a differential gear device 42 (DIFF) connected to a transmission output shaft 40 of the automatic transmission 38, left and right front-wheel axles 44 connected to the front wheels 14, an engine connection shaft 46 connecting between the engine 12 and the K0 clutch 34, and an electric-motor connection shaft 48 connecting between the K0 clutch 34 and the input clutch 36. It is noted that the automatic transmission 38 corresponds to “transmission” recited in the appended claims.

Inside the casing 32, the front electric motor FrMG is connected to the electric-motor connection shaft 48 in a power transmittable manner. The front electric motor FrMG is connected to the power transmission path in a power transmittable manner, and is located between the K0 clutch 34 and the input clutch 36 in the power transmission path. Therefore, the front electric motor FrMG is connected to the input clutch 36 and the automatic transmission 38 without through the K0 clutch 34, in a power transmittable manner.

The automatic transmission 38 is a known automatic transmission of a planetary gear type which includes at least one planetary gear device (not shown) and an engagement device CB. The engagement device CB includes, for example, a plurality of hydraulically-operated frictional coupling devices each of which is a multiple-disc type or a single-disc type clutch or brake that is to be pressed by a hydraulic actuator, or a band brake that is to be tightened by a hydraulic actuator. Each of the coupling devices of the engagement device CB is configured to receive a CB hydraulic pressure PRcb that is a regulated hydraulic pressure supplied from a hydraulic control unit (hydraulic control circuit) 52, whereby a CB torque Tcb, i.e., torque capacity of each coupling device of the engagement device CB is changed so that a control or operation state of the engagement device CB is switched between an engaged state and a released state, for example. A power transmission state of the automatic transmission 38 is changed depending on the operation state of the engagement device CB. Thus, the engagement device CB, which is located between the engine 12 and the front wheels 14 in the power transmission path and between the first electric motor FrMG and the front wheels 14 in the power transmission path, is configured to establish and cut off transmission of the power of each of the engine 12 and the first electric motor FrMG to the front wheels 14 through the power transmission path. It is noted that the engagement device CB corresponds to “transmission engagement device (provided in the transmission)” recited in the appended claims.

The automatic transmission 38 is a step-variable automatic transmission configured to establish a selected one of a plurality of gear positions, with a corresponding one or ones of the coupling devices of the engagement device CB being engaged, wherein the gear positions are different from each other in gear ratio (speed ratios) γat (=AT input rotational speed Ni/AT output rotational speed No). The automatic transmission 38 is configured to switch from one of the gear positions to another one of the gear positions, namely, to establish one of the gear positions which is selected, by the electronic control apparatus 100, depending on, for example, an accelerating operation made by a vehicle driver (operator) and a running speed V of the vehicle 10. The AT input rotational speed Ni is a rotational speed of a transmission input shaft 50 of the automatic transmission 38, and is an input rotational speed of the automatic transmission 38. It is noted that the transmission input shaft 50 corresponds to “input shaft (of the transmission)” recited in the appended claims, the AT input rotational speed Ni corresponds to “rotational speed (of the input shaft)” recited in the appended claims, the transmission output shaft 40 corresponds to “output shaft (of the transmission)” recited in the appended claims, and the AT output rotational speed No corresponds to “rotational speed (of the output shaft)” recited in the appended claims.

The K0 clutch 34 is a hydraulically-operated frictional engagement device constituted by a multiple-disc type or single-disc type clutch, wherein the clutch may be of either wet type or dry type, for example. A controlled or operation state of the K0 clutch 34 is to be switched among an engaged state, a slipping state and a released state, with a K0 torque Tk0 (that corresponds to a torque capacity of the K0 clutch 34) being changed by a K0 hydraulic pressure PRk0 that is regulated and supplied by the hydraulic control unit 52.

The input clutch 36 is a hydraulically-operated frictional engagement device constituted by a multiple-disc type or single-disc type clutch, wherein the clutch may be of either wet type or dry type, for example. A controlled or operation state of the input clutch 36 is to be switched among an engaged state, a slipping state and a released state, with a WSC torque Twsc (that corresponds to a torque capacity of the input clutch 36) being changed by a WSC hydraulic pressure PRwsc that is regulated and supplied by the hydraulic control unit 52.

When the K0 clutch 34 is in the engaged state, the engine 12 and the front electric motor FrMG are connected to each other through the engine connection shaft 46 and the electric-motor connection shaft 48 in a power transmittable manner. That is, with the K0 clutch 34 being engaged, the K0 clutch 34 connects between the engine 12 and the front electric motor FrMG in a power transmittable manner. On the other hand, when the K0 clutch 34 is in the released state, the power transmission between the engine 12 and the front electric motor FrMG is cut off. That is, with the K0 clutch 34 being released, the K0 clutch 34 disconnects the engine 12 and the front electric motor FrMG from each other. That is, the K0 clutch 34 a connection/disconnection clutch which is configured, when being engaged, to connect between the engine 12 and the front electric motor FrMG, and which is configured, when being released, to disconnect the engine 12 and the front electric motor FrMG from each other.

When the input clutch 36 is in the engaged state, the electric-motor connection shaft 48 and the transmission input shaft 50 are connected to each other. In this instance, the front electric motor FrMG is connected to the front wheels 14 through the electric-motor connection shaft 48, input clutch 36, transmission input shaft 50, transmission output shaft 40, differential gear device 42 and front-wheel axles 44, in a power transmittable manner. Further, when the K0 clutch 34 and the input clutch 36 are both in the engaged states, the engine 12 as well as the front electric motor FrMG is connected to the front wheels 14 through the electric-motor connection shaft 48, input clutch 36, transmission input shaft 50, transmission output shaft 40, differential gear device 42 and front-wheel axles 44, in a power transmittable manner. On the other hand, when the input clutch 36 is in the released state, the electric-motor connection shaft 48 and the transmission input shaft 50 are disconnected from each other. That is, the input clutch 36 is a connection/disconnection clutch which is configured, when being engaged, to connect the engine 12 and the front electric motor FrMG to the front wheels 14, and which configured, when being released, to disconnect the engine 12 and the front electric motor FrMG from the front wheels 14.

In the front unit 18, when the K0 clutch 34 and the input clutch 36 are both engaged, the power outputted from the engine 12 is transmitted to the front wheels 14 sequentially through the engine connection shaft 46, electric-motor connection shaft 48, transmission input shaft 50, automatic transmission 38, transmission output shaft 40, differential gear device 42 and front-wheel axles 44. Further, when the input clutch 36 is engaged, the power outputted from the front electric motor FrMG is transmitted to the front wheels 14 sequentially through the electric-motor connection shaft 48, transmission input shaft 50, automatic transmission 38, transmission output shaft 40, differential gear device 42 and front-wheel axles 44.

On the other hand, when the input clutch 36 is released, the engine 12 and the front electric motor FrMG are disconnected from the front wheels 14 in the power transmission path, so that the power of each of the engine 12 and the front electric motor FrMG is not transmitted to the front wheels 14. When the K0 clutch 34 is released and the input clutch 36 is engaged, the power of the front electric motor FrMG is transmitted to the front wheels 14 through the automatic transmission 38, for example, while the power of the engine 12 is not transmitted to the front wheels 14. When the K0 clutch 34 is engaged and the input clutch 36 is released, the power of each of the engine 12 and the front electric motor FrMG is not transmitted to the front wheels 14, but the engine 12 and the front electric motor FrMG are connected to each other in a power transmittable manner so that the electric power can be generated by the front electric motor FrMG that is driven by the power of the engine 12.

The rear unit 20 is constructed such the power of the rear electric motor RrMG is transmittable to the rear wheels 16. The rear unit 20 includes left and right rear-wheel axles 54 connected to the rear wheels 16, in addition to the above-described rear inverter 30 and rear electric motor RrMG that are to be controlled by the electronic control apparatus 100. The rear electric motor RrMG is connected to the rear-wheel axles 54 directly or indirectly through a speed reducer (not shown). Thus, the rear electric motor RrMG is connected to the rear wheels 16 through the rear-wheel axles 54, for example, in a power transmittable manner, so that the power outputted from the rear electric motor RrMG is transmittable to the rear wheels 16 through the rear-wheel axles 54, for example. It is noted that the rear wheels 16 correspond to “second wheels” recited in the appended claims and that the rear electric motor RrMG corresponds to “second electric motor” recited in the appended claims.

The vehicle 10 includes a mechanical oil pump (MOP) 58 and an electrical oil pump 60. The mechanical oil pump 58 is connected to the electric-motor connection shaft 48, for example, through gears, belts and/or chains in a power transmittable manner, and is to be driven by at least one of the engine 12 and the front electric motor FrMG so as to output a working fluid that is to be used in the front unit 18. The electrical oil pump 60 is to be driven by a pump motor (not shown) so as to output the working fluid. The working fluid OIL outputted by the mechanical oil pump 58 and the electrical oil pump 60 is supplied to the hydraulic control unit 52. The hydraulic control unit 52, which receives the working fluid OIL as an original hydraulic pressure, supplies regulated hydraulic pressures that serve as the CB hydraulic pressure PRcb, the K0 hydraulic pressure PRk0 and the WSC hydraulic pressure PRwsc, for example.

The vehicle 10 is provided with the electronic control apparatus 100 (control apparatus) including a control apparatus that is to be involved in running controls of the vehicle 10. The electronic control apparatus 100 includes a so-called microcomputer incorporating a CPU, a ROM, a RAM and an input-output interface. The CPU performs various control operations of the vehicle 10, by processing various input signals, according to control programs stored in the ROM, while utilizing a temporary data storage function of the RAM. The electronic control apparatus 100 includes a plurality of ECUs such as an engine control ECU, an electric-motor control ECU and a hydraulic control ECU.

The electronic control apparatus 100 receives various input signals based on values detected by respective sensors provided in the vehicle 10. Specifically, the electronic control apparatus 100 receives: an output signal of an engine speed sensor 70 indicative of an engine rotational speed Ne that is a rotational speed of the engine 12; an output signal of an input speed sensor 72 indicative of an AT input rotational speed Ni that is a rotational speed of the transmission input shaft 50 of the automatic transmission 38; an output signal of an output speed sensor 74 indicative of an AT output rotational speed No which is a rotational speed of the transmission output shaft 40 of the automatic transmission 38 and which corresponds to the vehicle running speed V; an output signal of an FrMG speed sensor 76 indicative of an FrMG rotational speed NmFr that is a rotational speed of the front electric motor FrMG; an output signal of an RrMG speed sensor 78 indicative of an RrMG rotational speed NmRr that is a rotational speed of the rear electric motor RrMG; an output signal of an accelerator-opening degree sensor 80 indicative of the accelerator opening degree (accelerator operation degree) θacc representing the amount of accelerating operation made by the vehicle driver; an output signal of a throttle-opening degree sensor 82 indicative of a throttle opening degree θth that is an opening degree of an electronic throttle valve; an output signal of a brake switch 84 which is a brake-ON signal Bon representing a state in which a brake pedal is being operated by the vehicle driver so as to operate wheel brakes; an output signal of a battery sensor 86 indicative of a battery temperature THbat, a battery charging/discharging electric current that and a battery voltage Vbat; and an output signal of a fluid temperature sensor 88 indicative of a working-fluid temperature THoil that is a temperature of the working fluid OIL in the hydraulic control unit 52.

The electronic control apparatus 100 generates various output signals to the various devices provided in the vehicle 10, such as: an engine control command signal Se that is to be supplied to the engine control device 22 for controlling the engine 12, an FrMG control command signal SmFr that is to be supplied to the front inverter 24 for controlling the front electric motor FrMG; an RrMG control command signal SmRr that is to be supplied to the rear inverter 30 for controlling the rear electric motor RrMG; a CB hydraulic control command signal Scb that is to be supplied to the hydraulic control unit 52 for controlling the operation states of the engagement device CB; a K0 hydraulic control command signal Sko that is to be supplied to the hydraulic control unit 52 for controlling the K0 clutch 34; WSC hydraulic control command signal Swsc that is to be supplied to the hydraulic control unit 52 for controlling the operation state of the input clutch 36; and a relay-switch control command signal Ssmr that is to be supplied to the system main relay 26 for switching an operation state of the system main relay 26. The operation state of the system main relay 26 is placed in a connection state by the relay-switch control command signal Ssmr, for example, when a power switch of the vehicle 10 is switched ON, whereby the electric power can be supplied from the HEV battery 28.

For performing various control operations in the vehicle 10, the electronic control apparatus 100 includes a hybrid control means in the form of a hybrid control portion 102, a clutch control means in the form of a clutch control portion 104, a shift control means in the form of a shift control portion 106, and a clutch-release determination means in the form of a clutch-release determination portion 108. It is noted that the clutch-release determination portion 108 corresponds to “determination portion” recited in the appended claims.

The hybrid control portion 102 has a function serving as an engine control means in the form of an engine control portion 102a for controlling operation of the engine 12, a function serving as an Fr-electric-motor control means in the form of an Fr-electric-motor control portion 102b for controlling operation of the front electric motor FrMG through the front inverter 24 and a function serving as an Rr-electric-motor control means in the form of an Rr-electric-motor control portion 102c for controlling operation of the rear electric motor RrMG through the rear inverter 30, and executes a hybrid-drive control operation, for example, using the engine 12, the front electric motor FrMG and the rear electric motor RrMG.

The hybrid control portion 102 calculates a requested drive amount of the vehicle 10 requested by the vehicle driver, by applying the accelerator opening degree θacc and the vehicle running speed V, for examples, to a requested drive amount map that represents a pre-stored relationship obtained by experimentation or determined by an appropriate design theory. The requested drive amount is, for example, a requested drive torque Trdem of the front and rear wheels 14, 16. From another point of view, the requested drive torque Trdem [Nm] is a requested drive power Prdem [W] at the current vehicle running speed V. As the requested drive amount, another value such as a requested drive force Frdem [N] of the front and rear wheels 14, 16 and a requested AT output torque of the transmission output shaft 40 of the automatic transmission 38 may be used, too. In the calculation of the requested drive amount, it is also possible to use, for example, the AT output rotational speed No in place of the vehicle running speed V.

The hybrid control portion 102 outputs an engine control command signal Se for controlling the engine 12, an FrMG control command signal SmFr for controlling the front electric motor FrMG, and an RrMG control command signal SmRr for controlling the rear electric motor RrMG, so as to realize the requested drive power Prdem, by taking account of various factors such as a transmission loss, an auxiliary load, the gear ratio γat of the automatic transmission 38 and a maximum chargeable amount Win and a maximum dischargeable amount Wout of the HEV battery 28. The engine control command signal Se is, for example, a command value of an engine power Pe that is the power of the engine 12 outputting the engine torque Te at the current engine rotational speed Ne. The FrMG control command signal SmFr is, for example, a command value of a consumed electric power WmFr of the front electric motor FrMG outputting the FrMG torque TmFr at the current FrMG rotational speed NmFr. The RrMG control command signal SmRr is, for example, a command value of a consumed electric power WmRr of the rear electric motor RrMG outputting the RrMG torque TmRr at the current RrMG rotational speed NmRr.

The maximum chargeable amount Win of the HEV battery 28 is a maximum amount of the electric power that can be charged to the HEV battery 28, and indicates an input limit of the HEV battery 28. The maximum dischargeable amount Wout of the HEV battery 28 is a maximum amount of the electric power that can be discharged from the HEV battery 28, and indicates an output limit of the HEV battery 28. The maximum chargeable and dischargeable amounts Win, Wout are calculated by the electronic control apparatus 100, for example, based on a battery temperature THbat and a charged state value SOC [%] of the HEV battery 28 that corresponds to a stored electric energy amount (charged electric energy amount) of the HEV battery 28. The charged state value SOC of the HEV battery 28 is a value indicative of a charged state of the HEV battery 28, and is calculated by the electronic control apparatus 100, for example, based on the charging/discharging electric current that and the voltage Vbat of the HEV battery 28.

When the requested drive torque Trdem can be covered by only the output of at least one of the front electric motor FrMG and the rear electric motor RrMG, the hybrid control portion 102 establishes a motor running (=BEV running) mode as a running mode. When the BEV running mode is established, the hybrid control portion 102 causes the vehicle 10 to perform a BEV (Battery Electric Vehicle) running with the K0 clutch 34 and the input clutch 36 being released and engaged, respectively, and with at least one of the front electric motor FrMG and the rear electric motor RrMG serving as the drive power source.

On the other hand, when the requested drive torque Trdem cannot be covered without at least the output of the engine 12, the hybrid control portion 102 establishes an engine running mode, i.e., a hybrid running (=HEV running) mode as the running mode. When the HEV running mode is established, the hybrid control portion 102 causes the vehicle 10 to perform an engine running, i.e., an HEV (Hybrid Electric Vehicle) running with the K0 clutch 34 and the input clutch 36 being both engaged and with at least the engine 12 serving as the drive power source. Further, even when the requested drive torque Trdem can be covered by only the output of at least one of the front electric motor FrMG and the rear electric motor RrMG, the hybrid control portion 102 establishes the HEV running mode, for example, in a case in which the state-of-charge value SOC of the HEV battery 28 becomes less than a predetermined engine-start threshold value or in a case in which the engine 12 or other component needs to be warmed up. The engine-start threshold value is a predetermined threshold value for determining that the state-of-charge value SOC reaches a level at which the engine 12 must forcibly be started for charging the HEV battery 28. Thus, the hybrid control portion 102 switches between the BEV running mode and the HEV running mode, based on, for example, the requested drive torque Trdem and the requested drive power Prdem, by automatically stopping the engine 12 during the HEV running, restarting the engine 12 after the stop of the engine 12, and staring the engine 12 during the BEV running.

The hybrid control portion 102 distributes the drive power to the front wheels 14 and the rear wheels 16 depending on a running state of the vehicle 10 such that the vehicle 10 can run with an appropriate running performance. When the vehicle 10 starts to run, is accelerated or runs on a slippy low friction-efficient road, the hybrid control portion 102 causes the vehicle 10 to perform a four-wheel drive running, i.e., run with the rear wheels 16 as well as the front wheels 14 being driven. In this instance, the hybrid control portion 102 calculates an appropriate drive power distribution ratio between the front and rear wheels 14, 16, based on the running state of the vehicle 10, and controls the outputs of the engine 12, front electric motor FrMG and rear electric motor RrMG such that an actual drive power distribution ratio between the front and rear wheels 14, 16 becomes substantially equal to the calculated drive power distribution ratio. For example, during running of the vehicle 10 in the HEV running mode, a part of the power of the engine 12 is transmitted as the drive power to the front wheels 14, while the remainder of the power of the engine 12 is transmitted to the front electric motor FrMG whereby the electric power can be generated by the front electric motor FrMG. Further, an electric power WgFr generated by the front electric motor FrMG is supplied to the rear electric motor RrMG, whereby the vehicle 10 is caused to run with the rear electric motor RrMG being driven.

In a low running speed region and/or a low-load region, the hybrid control portion 102 can cause the vehicle 10 to perform a series running. In this series running, an electric-power generation control is executed by rotating the front electric motor FrMG with use of the power of the engine 12 in a state in which the K0 clutch 34 is engaged while the power transmission through the automatic transmission 38 is cut off with the engagement device CB being released, and the electric power WgFr generated by the front electric motor FrMG is supplied to the rear electric motor RrMG, so that the vehicle 10 is caused to run with the rear electric motor RrMG being driven by the supplied electric power WgFr. In this instance, since the power transmission through the automatic transmission 38 is cut off, the power of each of the engine 12 and the front electric motor FrMG is not transmitted to the front wheels 14. The running mode in which the power of the engine 12 is used exclusively to rotate the front electric motor FrMG to generate the electric power WgFr and the vehicle 10 is caused to run with the power of the electric motor RrMG receiving the generated electric power WgFr, will be referred to as “series running mode”. This series running mode is established, for example, also in an evacuation running that is to be executed in event of detection of a failure in the vehicle 10.

During the series running, the hybrid control portion 102 determines requested electric power WgFr* based on the charged state value SOC of the HEV battery 28, for example, and determines a target engine rotational speed Ne* and a target engine torque Te* of the engine 12 and a target FrMG rotational speed NmFr* and a target FrMG torque TmFr* (regenerative torque) of the front electric motor FrMG, based on the determined requested electric power WgFr*. The hybrid control portion 102 controls the output of the engine 12 such that the engine 12 is operated with the determined target engine rotational speed Ne* and target engine torque Te*, and controls the output of the front electric motor FrMG such that the front electric motor FrMG is operated with the determined target FrMG rotational speed NmFr* and target FrMG torque TmFr*. For example, the Fr-electric-motor control portion 102b executes a feedback control (F/B control) for reducing a difference (=NmFr*—NmFr) between the actual FrMG rotational speed NmFr and the target FrMG rotational speed NmFr* of the front electric motor FrMG. With the F/B control being executed, the actual FrMG rotational speed NmFr of the front electric motor FrMG is caused to follow the target FrMG rotational speed NmFr* of the front electric motor FrMG. It is noted that the FrMG rotational speed NmFr corresponds to “rotational speed (of the first electric motor)” recited in the appended claims, and that the target FrMG rotational speed NmFr* corresponds to “target rotational speed (of the first electric motor)” recited in the appended claims.

During the HEV running in which the vehicle 10 is caused to run with at least the engine 12 serving as the drive power source, the clutch control portion 104 causes the K0 clutch 34 and the input clutch 36 to be both engaged so as to establish a state in which the power of the engine 12 is transmittable to the front wheels 14. During the motor running, the clutch control portion 104 causes the K0 clutch 34 and the input clutch 36 to be released and engaged, respectively, so as to establish a state in which the vehicle 10 can run by the front electric motor FrMG and/or the rear electric motor RrMG. During the running with deceleration, the clutch control portion 104 causes the input clutch 36 to be engaged so as to establish a state in which the front electric motor FrMG and the front wheels 14 are connected in a power transmittable manner whereby power regeneration can be made by the front electric motor FrMG. During the running in the series running mode, the clutch control portion 104 causes the K0 clutch 34 and the input clutch 36 to be engaged. In the present embodiment, during the running in the series running mode, the automatic transmission 38 is controlled to be placed in the neutral state, whereby the engine 12 is disconnected from the front wheels 14 in the power transmission path and also the front electric motor FrMG is disconnected from the front wheels 14 in the power transmission path.

The shift control portion 106 determines whether a shifting action is to be executed in the automatic transmission 38, by using, for example, a shifting map that represents a predetermined relationship, and outputs the CB hydraulic control command signal Scb, as needed, which is supplied to the hydraulic control unit 52, for executing the shifting action in the automatic transmission 38. In the shifting map, the predetermined relationship is represented by shifting lines in two-dimensional coordinates in which the vehicle running speed V and the requested drive torque Trdem as two variables are taken along respective two axes, wherein the shifting lines are used for the determination as to whether the shifting action is to be executed in the automatic transmission 38. In the shifting map, one of the two variables may be the AT output rotational speed No in place of the vehicle running speed V, and the other of the two variables may be any one of the requested drive force Frdem, accelerator opening degree θacc and throttle opening degree θth in place of the requested drive torque Trdem.

By the way, in the vehicle 10, when a failure is detected during running of the vehicle 10, the series running is executed as the evacuation running. To this end, the engagement device CB is to be released, namely, all of the coupling devices of the engagement device CB are to be released, so as to place the automatic transmission 38 into the neutral state. However, in event of stuck of a solenoid valve by which the operation state of one of the coupling devices of the engagement device CB, the engagement device CB cannot be controlled to be released. In such an event, there is a risk that a part of the engine torque Te, which outputs the power used for electric power generation during the series running, could be transmitted toward the front wheels 14 through the automatic transmission 38.

For avoiding the above-described risk, the clutch-release determination portion 108 is configured, when the series running is initiated, to determine whether the automatic transmission 38 is in the neutral state (power-transmission cut-off state) or not, namely, whether the engagement device CB of the automatic transmission 38 is being released or not.

When the series running is initiated, the clutch-release determination portion 108 calculates a rotational speed difference ΔNi (=|Ni−Niest|) between the AT input rotational speed Ni of the automatic transmission 38 and an estimated AT input rotational speed Niest, and determines whether the rotational speed difference ΔNi is equal to or smaller than a first predetermined value α1, wherein the estimated AT input rotational speed Niest is an estimated value of the AT input rotational speed Ni that is calculated based on the AT output rotational speed No and the gear ratio γat of the automatic transmission 38. The first predetermined value α1 is determined by experimentation or appropriate design theory, and is set to a threshold value such that it can be determined that the AT input rotational speed Ni coincides with or substantially coincides with the estimated AT input rotational speed Niest as long as the rotational speed difference ΔNi is not larger than the threshold value as the first predetermined value α1. It is noted that the estimated AT input rotational speed Niest corresponds to “estimated rotational speed (of the input shaft)” recited in the appended claims.

Any one of the gear positions could be established in the automatic transmission 38, depending on the operation state of each of the coupling devices of the engagement device CB of the automatic transmission 38, and the gear ratio γat of the automatic transmission 38 is changed depending on the gear position established. Therefore, the estimated AT input rotational speeds Niest are calculated for the gear gears γat of the respective gear positions, and the determination as to whether the above-described rotational speed difference ΔNi is equal to or smaller than the first predetermined value α1 or not is made for each of the estimated AT input rotational speeds Niest calculated for the gear gears γat of the respective gear positions.

When the rotational speed difference ΔNi between the AT input rotational speed Ni and the estimated AT input rotational speed Niest is not larger than the first predetermined value α1, one of the gear positions is established in the automatic transmission 38. Thus, the rotational speed difference ΔNcb between an input rotary member 90 and an output rotary member 92 that are connected or disconnected by the engagement device CB is a small value that makes it possible to determine that the engagement device CB is engaged. Therefore, the rotational speed difference ΔNcb between the input rotary member 90 and the output rotary member 92 that are connected and disconnected by the engagement device CB is estimated based on the rotational speed difference ΔNi between the AT input rotational speed Ni and the estimated AT input rotational speed Niest.

When determining that the rotational speed difference ΔNi has become not larger than the first predetermined value α1, the clutch-release determination portion 108 starts to measure an elapsed time T1 having elapsed from a time point of the determination that the rotational speed difference ΔNi has become not larger than the first predetermined value α1, and determines whether a state (i.e., first state) in which the rotational speed difference ΔNi is not larger than the first predetermined value α1 has lasted for at least a first predetermined time β1 or not. The first predetermined time β1 is determined by experimentation or appropriate design theory, and is set to a value that excludes, for example, a case in which the AT input rotational speed Ni temporarily coincides with the estimated AT input rotational speed Niest. Therefore, it is determined that the coincidence of the AT input rotational speed Ni with the estimated AT input rotational speed Niest is temporary and is within a range of error, when the above-described state in which the rotational speed difference ΔNi is not larger than the first predetermined value α1 has not lasted for at least the first predetermined time β1. The clutch-release determination portion 108 determines that the engagement device CB of the automatic transmission 38 is being released, in a case in which the rotational speed difference ΔNi does not become equal to or smaller than the first predetermined value α1, and in a case in which the above-described state (in which the rotational speed difference ΔNi is not larger than the first predetermined value α1) does not last for at least the first predetermined time β1.

On the other hand, the clutch-release determination portion 108 determines that the AT input rotational speed Ni coincides with or substantially coincides with the estimated AT input rotational speed Niest, when the case in which the rotational speed difference ΔNi is not larger than the first predetermined value α1 has lasted for at least the first predetermined time β1. Thus, it is assumed that the engagement device CB of the automatic transmission 38 is engaged when the AT input rotational speed Ni coincides with or substantially coincides with the estimated AT input rotational speed Niest. However, since the pair of front wheels 14 and the pair of rear wheels 16 are driven independently of each other in the vehicle 10, the AT input rotational speed Ni could accidentally coincide with to or substantially coincides with the estimated AT input rotational speed Niest, even though the engagement device CB is not engaged.

Therefore, when determining that the AT input rotational speed Ni coincides with or substantially coincides with the estimated AT input rotational speed Niest, the clutch-release determination portion 108 further determines whether the engagement device CB is being released or not, based on a rotational state of the front electric motor FrMG. Specifically, when determining that the AT input rotational speed Ni coincides with or substantially coincides with the estimated AT input rotational speed Niest, the clutch-release determination portion 108 determines whether the FrMG rotational speed NmFr of the front electric motor FrMG is deviated from a target FrMG rotational speed NmFr* of the front electric motor FrMG or not. It is noted that the target FrMG rotational speed NmFr* of the front electric motor FrMG is value that is calculated, as needed, based on a requested electric power WgFr* generated by the front electric motor FrMG, for example.

For making the determination as to whether the FrMG rotational speed NmFr of the front electric motor FrMG is deviated from the target FrMG rotational speed NmFr* or not, the clutch-release determination portion 108 firstly calculates a deviation amount ΔNmFr (=|NmFr−NmFr*|) between the FrMG rotational speed NmFr and the target FrMG rotational speed NmFr* of the front electric motor FrMG, and then determines whether the calculated deviation amount ΔNmFr is equal to or larger than a predetermined second predetermined value α2. The second predetermined value α2 is determined by experimentation or appropriate design theory, and is set to a threshold value such that it can be determined that the FrMG rotational speed NmFr is deviated from the target FrMG rotational speed NmFr* as long as the deviation amount ΔNmFr is not smaller than the threshold value as the second predetermined value α2.

When determining that the deviation amount ΔNmFr has become not smaller than the second predetermined value α2, the clutch-release determination portion 108 starts to measure an elapsed time T2 having elapsed from a time point of the determination that the deviation amount ΔNmFr has become not smaller than the second predetermined value α2, and determines whether a state (i.e., second state) in which the deviation amount ΔNmFr is not smaller than the second predetermined value α2 has lasted for at least a second predetermined time β2 or not. The second predetermined time β2 is determined by experimentation or appropriate design theory, and is set to a value that excludes, for example, a case in which the FrMG rotational speed NmFr is temporarily deviated from the target FrMG rotational speed NmFr*. Therefore, it is determined that the deviation of the FrMG rotational speed NmFr from the target FrMG rotational speed NmFr* is temporary and is within a range of error, when the above-described state in which the deviation amount ΔNmFr is not smaller than the second predetermined value α2 has not lasted for at least the second predetermined time β2. The clutch-release determination portion 108 determines that the FrMG rotational speed NmFr is not deviated from the target FrMG rotational speed NmFr*, in a case in which the deviation amount ΔNmFr does not become equal to or larger than the second predetermined value α2, and in a case in which the above-described state (in which the deviation amount ΔNmFr is not smaller than the second predetermined value α2) does not last for at least the second predetermined time β2. In a case in which the FrMG rotational speed NmFr is not deviated from the target FrMG rotational speed NmFr*, it is determined that the coincidence or substantial coincidence of the AT input rotational speed Ni with the estimated AT input rotational speed Niest is accidental, and that the engagement device CB is being released.

On the other hand, in a case in which the state in which the rotational speed difference ΔNi is not larger than the first predetermined value α1 lasts for at least the first predetermined time β1 and the state in which the deviation amount ΔNmFr between the FrMG rotational speed NmFr and the target FrMG rotational speed NmFr* is not smaller than second predetermined value α2 lasts for at least the second predetermined time β2, the clutch-release determination portion 108 determines that the engagement device CB is engaged. During the series running, the above-described F/B control is executed whereby the FrMG rotational speed NmFr of the front electric motor FrMG is controlled to follow the target FrMG rotational speed NmFr* of the front electric motor FrMG. In this instance, if the engagement device CB of the automatic transmission 38 is engaged, the power of the engine 12 is transmitted through the automatic transmission 38 toward the front wheels 14, thereby resulting in reduction of followability of the FrMG rotational speed NmFr and deviating the FrMG rotational speed NmFr from the target FrMG rotational speed NmFr*. Therefore, in a case in which the FrMG rotational speed NmFr is deviated from the target FrMG rotational speed NmFr*, it is determined that the engagement device CB is being engaged.

When it is determined by the clutch-release determination portion 108 that the engagement device CB is engaged, the hybrid control portion 102 stops the series running and executes a rear motor running by the rear electric motor RrMG. In the rear motor running, the engine 12 is stopped and the power generation by the front electric motor FrMG is stopped. That is, the power outputted from the front unit 18 is zeroed, and the running is executed by the rear electric motor RrMG with use of the electric power of the HEV battery 28. Thus, in a case in which the engagement device CB is engaged in the automatic transmission 38, the series running is changed to the rear motor running that is performed with use of the electric power of the HEV battery 28, for thereby ensuring the running of the vehicle 10 in a safe state.

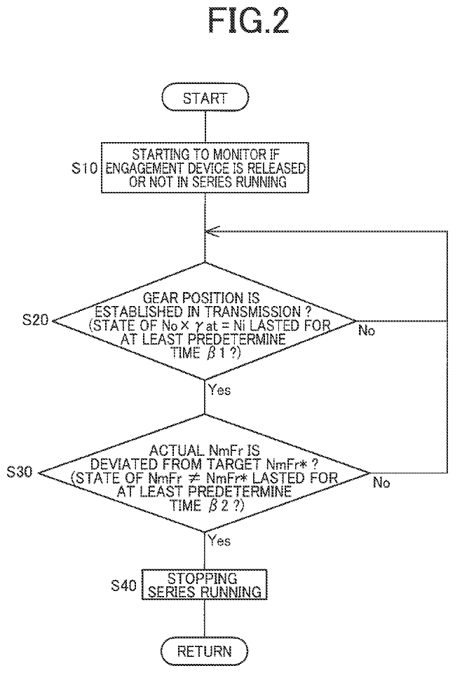

FIG. 2 is a flow chart showing a main part of a control routine executed by the electronic control apparatus 100, so as to determine whether the engagement device CB of the automatic transmission 38 is being released or not, during the series running. This control routine is executed in a repeated manner during the series running.

As shown in FIG. 2, this control routine is initiated with step S10 corresponding to control function of the clutch-release determination portion 108, which is implemented, when the series running mode is established, to start a control for monitoring if the engagement device CB of the automatic transmission 38 is in the released state. Then, step S20 corresponding to control function of the clutch-release determination portion 108 is implemented to determine whether any one of the gear positions is established in the automatic transmission 38. Specifically, at step S20, it is determined whether the state in which the AT input rotational speed Ni coincides with or substantially coincides with the estimated AT input rotational speed Niest (=No×γat), i.e., the state in which the rotational speed difference ΔNi between the AT input rotational speed Ni and the estimated AT input rotational speed Niest is not larger than the first predetermined value α1, has lasted for at least the first predetermined time β1. When a negative determination is made at step S20, the control flow goes back to step S20 whereby the determination as to whether any one of the gear positions is established in the automatic transmission 38 is continuously made. When an affirmative determination is made at step S20, step S30 corresponding to control function of the clutch-release determination portion 108 is implemented to determine whether the state in which the FrMG rotational speed NmFr of the front electric motor FrMG is deviated from the target FrMG rotational speed NmFr*, i.e., the state in which the deviation amount ΔNmFr between the FrMG rotational speed NmFr and the target FrMG rotational speed NmFr* is not smaller than the second predetermined value α2, has lasted for at least the second predetermined time β2. When a negative determination is made at step S30, the control flow goes back to step S20 whereby the determination as to whether any one of the gear positions is established in the automatic transmission 38 is continuously made. When an affirmative determination is made at step S30, it is determined that one of the gear positions is established in the automatic transmission 38, namely, the engagement device CB of the automatic transmission 38 is being engaged, and step S40 corresponding to control function of the hybrid control portion 102 is implemented to stop the series running and to execute the rear motor running by the rear electric motor RrMG with use of the electric power of the HEV battery 28. Thus, during the series running, the determine as to whether the engagement device CB is being released or not can be accurately made depending on the rotational speed difference ΔNi between the AT input rotational speed Ni and the estimated AT input rotational speed Niest and the deviation amount ΔNmFr between the FrMG rotational speed NmFr and the target FrMG rotational speed NmFr*.

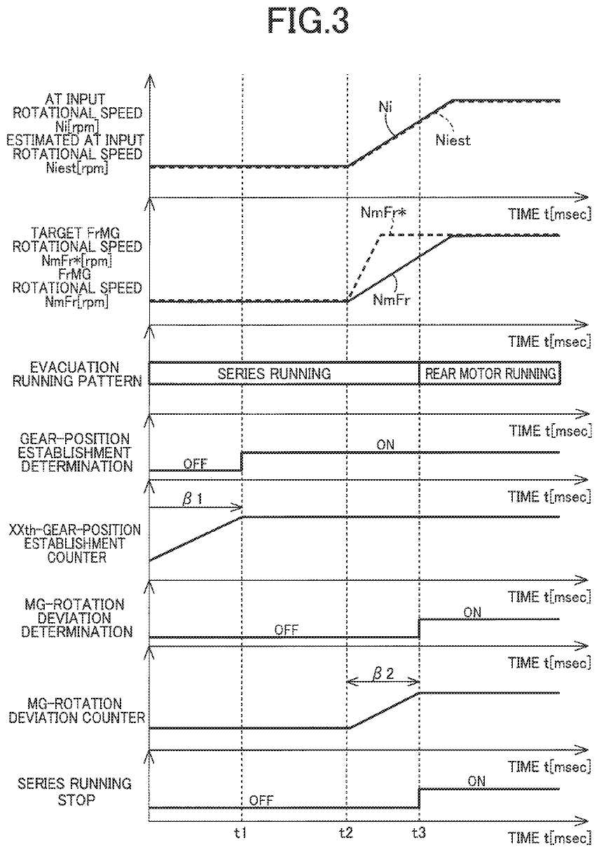

FIG. 3 is a time chart showing, by way of examples, outcomes of controls executed by the electronic control apparatus 100 shown in FIG. 1. Specifically, the time chart of FIG. 3 represents a case in which the engagement device CB of the automatic transmission 38 is engaged during the series running. It is noted that, since the input clutch 36 is engaged during the series running, the AT input rotational speed Ni and the FrMG rotational speed NmFr shown in FIG. 3 are made equal to each other.

In the time chart of FIG. 3, the series running is being executed since before a time point t1. As shown in FIG. 3, the state in which the AT input rotational speed Ni coincides with the estimated AT input rotational speed Niest lasts since before the time point t1, and the elapsed time T1 having elapsed from the time point of the determination that AT input rotational speed Ni has become coincident with the estimated AT input rotational speed Niest is measured. In connection with this, an XXth-gear-position establishment counter indicative of increase of the elapsed time T1 is increased. At the time point t1, when the elapsed time T1 reaches the first predetermined time β1, it is determined that a certain one of the gear positions is established in the automatic transmission 38, and a gear-position establishment determination is switched from OFF to ON, as shown in FIG. 3. Then, a determination as to whether the FrMG rotational speed NmFr of the front electric motor FrMG is deviated from the target FrMG rotational speed NmFr* of the front electric motor FrMG or not, is initiated. At a time point t2, the FrMG rotational speed NmFr starts to be deviated from the target FrMG rotational speed NmFr*, and the elapsed time T2 starts to be measured. In connection with this, an MG-rotation deviation counter indicative of increase of the elapsed time T2 is increased. At a time point t3, when the elapsed time T2 from the time point t2 reaches the second predetermined time β2, it is determined that the FrMG rotational speed NmFr is deviated from the target FrMG rotational speed NmFr*. In this instance, the series running is stopped and an evacuation running pattern is switched from the series running to the rear motor running. Thus, not only the determination as to whether the AT input rotational speed Ni with the estimated AT input rotational speed Niest or not, but also the determination as to whether the FrMG rotational speed NmFr is deviated from the target FrMG rotational speed NmFr* or not, is made so that it is possible to accurately determine whether the engagement device CB is being released or not.

As described above, in the present embodiment, during the running of the vehicle 10 in the series running mode in which the vehicle 10 is caused to run by the power of the rear electric motor RrMG with the engagement device CB being released, it is determined whether the engagement device CB is being released or not, based on (a) the rotational speed difference ΔNi between the AT input rotational speed Ni and the estimated AT input rotational speed Niest and (b) the rotational state of the front electric motor FrMG. Therefore, even in a case in which the AT input rotational speed Ni and the estimated AT input rotational speed Niest accidently coincide with each other even through the engagement device CB is actually being released, it is possible to accurately determine whether the engagement device CB is being released or not, because the rotational state of the front electric motor FrMG is taken into account in the determination as to whether the engagement device CB is being released or not.

Further, in the present embodiment, the rotational speed difference ΔNcb between the input rotary member 90 and the output rotary member 92 of the engagement device CB is estimated based on the rotational speed difference ΔNi between the AT input rotational speed Ni of the automatic transmission 38 and the estimated AT input rotational speed Niest of the automatic transmission 38 which is calculated from the AT output rotational speed No of the automatic transmission 38 and the gear ratio γat of the automatic transmission 38. Therefore, the rotational speed difference ΔNcb between the input rotary member 90 and the output rotary member 92 can be estimated by a sensor that is conventionally provided, even without additional provision of a sensor configured to detect the rotational speed of the input rotary member 90 and the rotational speed of the output rotary member 92 of the engagement device CB. Further, during execution of the series running, there is a case in which, even though the engagement device CB is actually released, the AT input rotational speed Ni and the estimated AT input rotational speed Niest accidently coincide with each other, due to rotation of the front electric motor FrMG that is caused by the power outputted by the engine 12. Even in such a case, since the rotational state of the front electric motor FrMG is taken into account in the determination as to whether the engagement device CB is being released or not. Therefore, it is possible to accurately determine whether the engagement device CB is being released or not.

There will be described another embodiment of this disclosure. The same reference signs as used in the above-described embodiment will be used in the following embodiment, to identify the practically corresponding elements, and descriptions thereof are not provided.

### Second Embodiment

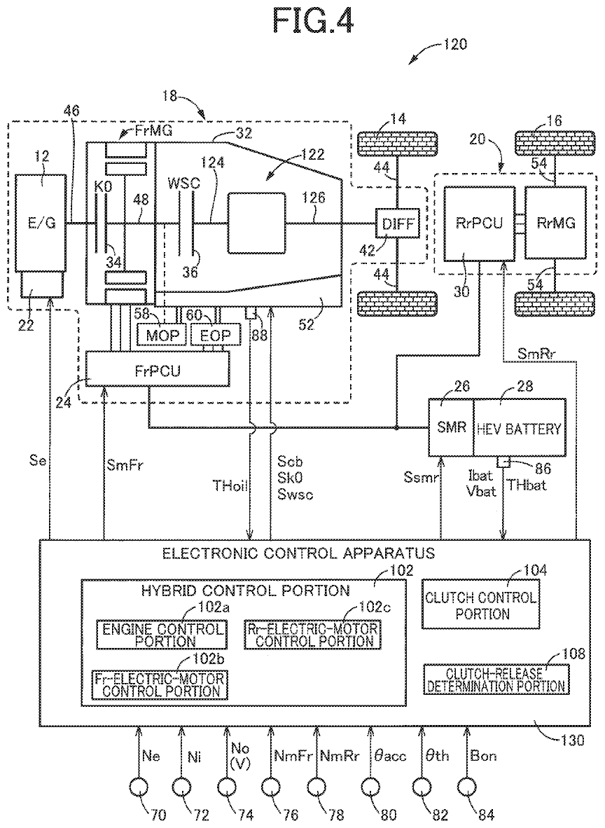

FIG. 4 is a view schematically showing a construction of a hybrid electric vehicle 120 (hereinafter simply referred to as “vehicle 120”) according to the second embodiment of the present disclosure. In the vehicle 120, the automatic transmission 38 (that is provided in the vehicle 10 according to the above-described first embodiment) is replaced by a speed reducer 122 that provides a constant gear ratio. The speed reducer 122 includes a speed-reducer input shaft 124 connected to the input clutch 36 and a speed-reducer output shaft 126 connected to the differential gear device 42. The other parts of the vehicle 120 are substantially the same in construction as the corresponding parts of the vehicle 10 of the above-described first embodiment, so that their description is not provided. Further, the vehicle 120 includes an electronic control apparatus 130 for performing various control operations in the vehicle 120. The electronic control apparatus 130 is basically the same as the electronic control apparatus 100 in the above-described first embodiment, only except that the electronic control apparatus 130 does not functionally includes the shift control portion 106. It is noted that the electric-motor connection shaft 48 corresponds to “input rotary member” recited in the appended claims and that the speed-reducer input shaft 124 corresponds to “output rotary member” recited in the appended claims.

In the vehicle 120, during the series running, the input clutch 36 is released so that the power transmission between the engine 12 and the front wheels 14 and the power transmission between the front electric motor FrMG and the front wheels 14 are cut off. In connection with this, the clutch-release determination portion 108 is configured, during the series running, to determine whether the input clutch 36 is being released or not, based on a rotational speed difference between the electric-motor connection shaft 48 and the speed-reducer input shaft 124. Further, when determining that a rotational speed of the electric-motor connection shaft 48 and a rotational speed of the speed-reducer input shaft 124 coincide or substantially coincide with each other, the clutch-release determination portion 108 determines whether the input clutch 36 is being released or not, based on a rotational state of the front electric motor FrMG. It is noted that, in this second embodiment, the input clutch 36 corresponds to “engagement device” recited in the appended claims. In the control arrangement in this second embodiment, it is possible to determine whether the input clutch 36 is being released or not during the series running, so that substantially the same effects can be obtained as in the above-described first embodiment.

While the embodiments of this disclosure have been described in detail by reference to the drawings, it is to be understood that the disclosure may be otherwise embodied.

For example, in the above-described first embodiment, it is determined whether the engagement device CB of the automatic transmission 38 is being released or not, based on the deviation amount ΔNmFr between the FrMG rotational speed NmFr and the target FrMG rotational speed NmFr* of the front electric motor FrMG. However, this determination as to whether the engagement device CB is being released or not, may be made based on a deviation amount between the engine rotational speed Ne and the target engine rotational speed Ne* of the engine 12, in place of the above-described deviation amount ΔNmFr.

In the above-described embodiments, when the engagement device CB of the automatic transmission 38 or the input clutch 36 is being released, the electric-power generation control is executed by causing the front electric motor FrMG to be rotated with use of the power of the engine 12. However, the electric-power generation control does not necessarily have to be executed.

In the above-described second embodiment, the vehicle 120 is provided with the speed reducer 122 that is located between the engine 12 and the front wheels 14 in the power transmission path and between the front electric motor FrMG and the front wheels 14 in the power transmission path. However, the provision of the speed reducer 122 is not essential, and the speed reducer 122 does not necessarily have to be provided in the vehicle 120. Further, a speed increaser may be provided in place of the speed reducer 122.

In the above-described embodiments, each of the engine 12 and the front electric motor FrMG is connected to the front wheels 14 in a power transmittable manner, while the rear electric motor RrMG is connected to the rear wheels 16 in a power transmittable manner. However, the arrangement may be modified such that the front electric motor FrMG is connected to the front wheels 14 in a power transmittable manner while each of the engine 12 and the rear electric motor RrMG is connected to the rear wheels 16 in a power transmittable manner. In this modified arrangement, the series running is performed by the front electric motor FrMG receiving the electric power, which is generated by the rear electric motor RrMG driven by the force of the engine 12 by execution of the electric-power generation control. Further, in the modified arrangement, the automatic transmission 38 or an engagement device is located between the engine 12 and the rear wheels 16 in the power transmission path and between the rear electric motor RrMG and the rear wheels 16 in the power transmission path, and the engagement device CB of the automatic transmission 38 or the engagement is released during the series running.

In the above-described first embodiment, the automatic transmission 38 is the step-variable transmission constituted by the at least one planetary gear device and the engagement device CB that includes the coupling devices. However, the automatic transmission 38 may be modified, for example, to be constituted by a forward/reverse switching device and a belt-type continuously-variable transmission. In this modification, during the series running, an engagement device provided in the forward/reverse switching device is released whereby the power transmission between the engine 12 and the front wheels 14 and the power transmission between the front electric motor FrMG and the front wheels 14 are cut off. That is, the present disclosure is applicable to any transmission which is provided between the engine 12 and the front wheels 14 in the power transmission path and between the front electric motor FrMG and the front wheels 14 in the power transmission path, and which is configured to cut off the power transmission through power transmission path during the series running.

In the above-described first embodiment, during the series running, the power transmission between the engine 12 and the front wheels 14 and the power transmission between the front electric motor FrMG and the front wheels 14 are cut off by cutting off the power transmission through the automatic transmission 38. However, the arrangement may be modified such that the power transmission between the engine 12 and the front wheels 14 and the power transmission between the front electric motor FrMG and the front wheels 14 may be cut off by releasing the input clutch 36. In this modified arrangement, during the series running, it is determined whether the input clutch 36 is being released or not, based on a difference between the FrMG rotational speed NmFr (i.e., the rotational speed of the electric-motor connection shaft 48) and the AT input rotational speed Ni (i.e., the rotational speed of the transmission input shaft 50).

In the above-described first embodiment, the input clutch 36 (WSC) is provided between the front electric motor FrMG and the automatic transmission 38 in the power transmission path. However, the input clutch 36 does not necessarily have to be provided but may be omitted.

It is to be understood that the embodiments described above are given for illustrative purpose only, and that the present disclosure may be embodied with various modifications and improvements which may occur to those skilled in the art.

### NOMENCLATURE OF ELEMENTS

10; 120: hybrid electric vehicle
12: engine
14: front wheels (first wheels)
16: rear wheels (second wheels)
36: input clutch (engagement device)
38: automatic transmission (transmission)
40: transmission output shaft (output shaft)
48: electric-motor connection shaft (input rotary member)
50: transmission input shaft (input shaft)
90: input rotary member
92: output rotary member
100; 130: electronic control apparatus (control apparatus)
102: hybrid control portion
108: clutch-release determination portion (determination portion)
124: speed-reducer input shaft (output rotary member)
FrMG: front electric motor (first electric motor)
RrMG: rear electric motor (second electric motor)
CB: engagement device (transmission engagement device)
Ni: AT input rotational speed (rotational speed of input shaft)
Niest: estimated AT input rotational speed (estimated rotational speed of input shaft)
No: AT output rotational speed (rotational speed of output shaft)
NmFr: FrMG rotational speed (rotational speed of first electric motor)
NmFr*: target FrMG rotational speed NmFr
   (target rotational speed of first electric motor)
ΔNi: rotational speed difference (=|Ni−Niest|)
ΔNmFr: deviation amount (=|NmFr−NmFr*|)
α1: first predetermined value
α2: second predetermined value
β1: first predetermined time
β2: second predetermined time

What is claimed is:

1. A control apparatus for a hybrid electric vehicle that includes (i) an engine, (ii) a first electric motor, (iii) a second electric motor, (iv) first wheels to which a power of each of the engine and the first electric motor is transmittable, (v) second wheels to which a power of the second electric motor is transmittable, and (vi) an engagement device which is provided in a power transmission path such that the engagement device is located between the engine and the first wheels in the power transmission path and between the first electric motor and the first wheels in the power transmission path,
wherein the engagement device is configured to establish and cut off transmission of the power of each of the engine and the first electric motor to the first wheels, by connecting and disconnecting between an input rotary member and an output rotary member,
wherein the control apparatus is configured to establish a running mode in which the engagement device is released and the vehicle is caused to run by the power of the second electric motor, and
wherein the control apparatus comprises a determination portion configured, during running of the vehicle in the running mode, to determine whether the engagement device is being released or not, based on (a) a rotational speed difference between the input rotary member and the output rotary member and (b) one of a rotational state of the engine and a rotational state of the first electric motor.

2. The control apparatus according to claim 1,
wherein the vehicle includes a transmission provided in the power transmission path, and the engagement device is a transmission engagement device provided in the transmission, and
wherein the determination portion is configured to estimate the rotational speed difference between the input rotary member and the output rotary member, based on a rotational speed difference between a rotational speed of an input shaft of the transmission and an estimated rotational speed of the input shaft that is calculated from a rotational speed of an output shaft of the transmission and a gear ratio of the transmission.

3. The control apparatus according to claim 1, further comprising a hybrid control portion configured, during running of the vehicle in the running mode, to execute a series running of the vehicle in which an electric power is generated by the first electric motor that is rotated with use of the power of the engine, and the vehicle is caused to run by the second electric motor to which the electric power generated by the first electric motor is supplied.

4. The control apparatus according to claim 1,
wherein the determination portion is configured to determine that the engagement device is being engaged, in a case in which a first state has lasted for at least first predetermined time and a second state has lasted for at least second predetermined time,
wherein the first state is a state in which the rotational speed difference between the input rotary member and the output rotary member is not larger than a first predetermined value, and
wherein the second state is a state in which a deviation amount between a rotational speed of one of the engine and the first electric motor and a target rotational speed of the one of the engine and the first electric motor is not smaller than a second predetermined value.
